(19) United States
(12) Patent Application Publication
(10) Pub. No.: US 2008/0029281 A1
(43) Pub. Date: Feb. 7, 2008

(54) Pneumatic tool

(76) Inventors: Yung-yung Sun, Dali City (TW); Chuan-Ching Cheng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/889,786

(22) Filed: Aug. 16, 2007

Related U.S. Application Data
(63) Continuation-in-part of application No. 11/411,779, filed on Apr. 27, 2006, now abandoned.

(51) Int. Cl. B25D 9/00

(52) U.S. Cl. 173/104

(57) ABSTRACT

A pneumatic tool including a cylindrical main body in which a speed-adjusting section is disposed and a hollow barrel-shaped plastic sleeve fitted around the main body. The speed-adjusting section has an end section which is radially connected with an inner annular wall. Two opposite pin seats are disposed on one side of the plastic sleeve. Each pin seat has a pinhole. A pin member is fitted through two lugs of a press lever and the pinholes of the pin seats to pivotally connect the press lever with the plastic sleeve. After the plastic sleeve is fitted around the main body, an annular receiving space is defined between an outer circumference of the annular wall of the main body and an inner circumference of the plastic sleeve. The annular receiving space is not occupied by any other component so that an annular muffling member can be accommodated in the annular receiving space. In addition to the original annular muffling member, another annular muffling member with the same size and specification can be further installed in the rear end of the plastic sleeve to enhance the muffling effect.

This application is a Continuation-In-Part Application of Ser. No. 11/411,779, filed Apr. 27, 2006, and entitled “PNEUMATIC TOOL HAVING MAIN BODY AND SLEEVE RECEIVING MUFFLER MEMBER THEREBETWEEN”

### BACKGROUND OF THE INVENTION

The present invention is related to an improved pneumatic tool in which the press lever is pivotally connected with the pin seats of the plastic sleeve. Two muffling members with the same specification are installed in the rear end of the plastic sleeve to enhance the muffling effect.

FIGS. 4 to 6 show a conventional pneumatic tool having a handle main body 61. The handle main body 61 is an elongated cylindrical body made of a hard metal material by means of milling and processing. One end of the handle main body 61 has a solid coupling section 62 formed with a pinhole 63. Only after the handle main body 61 is processed, the handle main body 61 can be drilled with the pinhole 63. In addition, the handle main body 61 has an inner annular wall 64 integrally connected with the solid coupling section 62. A plastic sleeve 71 is fitted around the handle main body 61 for a user to hold. The plastic sleeve 71 is a tubular body made by plastic injection molding. The plastic sleeve 71 is formed with a window 72 on one side. After the handle main body 61 is assembled with the plastic sleeve 71, two lugs 681 of a press lever 68 extend through the window 72 into the plastic sleeve 71 and a pin member 682 is fitted through the pinhole 63 and the lugs 681 to pivotally connect the press lever 68 with the handle main body 61. An annular muffling member 73 is mounted at a rear end of the plastic sleeve 71. When the air is exhausted from the pneumatic motor (not shown) in the handle main body 61, the air goes through the muffling member 73 to muffle the noise.

The conventional pneumatic tool has some shortcomings as follows:
1. It is complicated to process the handle main body 61 and the manufacturing cost is high. The handle main body 61 is made of hard metal material. After a blank of the handle main body 61 is molded by means of a mold, it is necessary to first mill the blank and then drill the solid coupling section 62 with the pinhole 63 for pivotally connecting the press lever 68 with the handle main body 61. Such processing procedure is complicated.
2. It is impossible to install another muffling member in the handle main body 61 to effectively muffle the noise generated when exhausting the air. This is because the solid coupling section 62 of the handle main body 61 is integrally connected with the annular wall 64. The solid coupling section 62 occupies the room between the inner circumference of the handle main body 61 and the annular wall 64. Therefore, it is impossible to additionally install another muffling member in the handle main body 61. As a result, when the air is exhausted from the pneumatic motor in the handle main body 61, only the muffling member 73 installed at the rear end of the plastic sleeve 71 serves to muffle the noise. The muffling effect is limited.

U.S. Patent Publication No. 5,022,469 discloses a pneumatic tool with muffling effect. Before exhausted from the pneumatic tool, the waste gas first passes through a longitudinal passage and an annular chamber and then passes through a perforated stopper plate for stopping the airflow. When the airflow passes through a first layer of muffling cotton, the airflow is preliminarily muffled. Then the airflow goes to a room to be further muffled by a second layer of muffling cotton. Then the airflow is exhausted from the exhaustion port.

One end of the first layer of muffling cotton is stopped by the stopper plate, while the other end of the first layer of muffling cotton is pressed against an annular section and located. There are double layers of muffling cottons for the waste gas from the longitudinal passage to the exhaustion port. However, the receiving space for the first layer of muffling cotton is apparently smaller than the receiving space of the second layer of muffling cotton. Therefore, only a small layer of muffling cotton can be accommodated in the first receiving space. As a result, the muffling effect achieved by the first layer of muffling cotton is poorer. The perforated stopper plate is added to stop the airflow. However, this increases the manufacturing cost. Therefore, the conventional muffling structure of the pneumatic tool is relatively complicated and has more components. It is tried by the applicant to provide a simplified muffling structure for the pneumatic tool to achieve better muffling effect and lower the manufacturing cost.

### SUMMARY OF THE INVENTION

It is therefore a primary object of the present invention to provide an improved pneumatic tool in which the pinholes of the plastic sleeve are formed at the same time when the plastic sleeve is molded. Therefore, the press lever can be directly pivotally connected with the pin seats of the plastic sleeve to simplify the processing procedure of the main body.

It is a further object of the present invention to provide the above pneumatic tool in which when the plastic sleeve is fitted around the main body, an annular receiving space is defined between an outer circumference of the annular wall of the main body and an inner circumference of the plastic sleeve. An annular muffling member can be fitted in the annular receiving space around the annular wall in addition to the original muffling member installed in the rear end of the plastic sleeve. Therefore, the two muffling members can achieve enhanced muffling effect to reduce the noise.

According to the above objects, the pneumatic tool of the present invention includes:

a cylindrical main body in which a speed-adjusting section is disposed, the speed-adjusting section having an end section through which waste gas can pass, the end section being radially connected with an inner annular wall which axially outward protrudes from the end section of the speed-adjusting section of the main body, the annular wall having an outer diameter smaller than an outer diameter of the main body; and

a hollow barrel-shaped plastic sleeve fitted around the main body, two opposite pin seats being disposed on one side of the plastic sleeve, each pin seat having a pinhole, a pin member being fitted through two lugs of a press lever and the pinholes of the pin seats to pivotally connect the press lever with the plastic sleeve, the plastic sleeve having an end section immediately adjacent to the inner annular wall of the main body, through which end section the waste gas can pass, a first annular receiving space being formed on outer side of the end section of the plastic sleeve, a first annular muffling member being accommodated in the first annular receiving space, a second annular receiving space being defined between an outer circumference of the annular wall of the main body and an inner circumference of the plastic sleeve, in the second receiving space, there being no component connecting with the inner annular wall of the main body and the plastic sleeve, whereby the second receiving space is not occupied by any other component, a second annular muffling member being disposed in the second annular receiving space and fitted around the annular wall, two ends of the second annular muffling member respectively abutting against the end sections of the speed-adjusting section and the plastic sleeve, which end sections permit the waste gas to pass through, the first and second annular muffling members having the same size.

The present invention can be best understood through the following description and accompanying drawings wherein:

### BRIEF DESCRIPTION OF THE DRAWINGS

FIG. 1 is a perspective exploded view of the present invention;

FIG. 2 is a partially sectional assembled view of the present invention;

FIG. 3 is a sectional view taken along line 3-3 of FIG. 2;

FIG. 4 is a perspective exploded view of a conventional pneumatic tool;

FIG. 5 is a partially sectional assembled view of the conventional pneumatic tool; and

FIG. 6 is a sectional view taken along line 6-6 of FIG. 5.

### DETAILED DESCRIPTION OF THE PREFERRED EMBODIMENTS

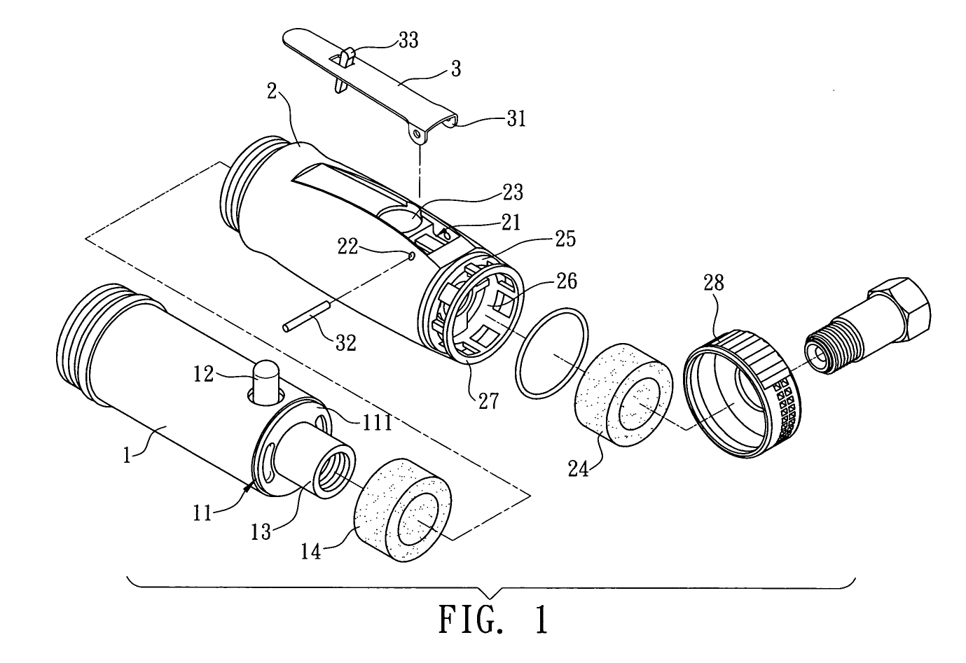

Please refer to FIGS. 1 to 3. The pneumatic tool of the present invention includes a cylindrical main body 1 made of hard metal material. A speed-adjusting section 11 is disposed in the main body 1. A press button 12 is radially mounted on the speed-adjusting section 11. One end of the press button 12 protrudes from a circumference of the main body 1. The speed-adjusting section 11 has an end section 111 through which the waste gas can pass. The end section 111 is radially connected with an inner annular wall 13 which axially outward protrudes from the end section 111 of the speed-adjusting section 11 of the main body 1. The annular wall 13 has an outer diameter smaller than an outer diameter of the main body 1.

The pneumatic tool of the present invention further includes a hollow barrel-shaped plastic sleeve 2. Two opposite pin seats 21 are disposed on one side of the plastic sleeve 2. Each pin seat 21 has a pinhole 22. A pin member 32 is fitted through two lugs 31 of one end of a press lever 3 and the pinholes 22 of the pin seats 21 to pivotally connect the press lever 3 with the plastic sleeve 2. A freely switchable safety switch 33 is pivotally connected with the other end of the press lever 3. In addition, the plastic sleeve 2 is formed with a radial through hole 23 near the pin seats 21. The end of the press button 12 protrudes from the circumference of the main body 1 and extends through the through hole 23 to be pressed by the press lever 3. The plastic sleeve 2 has an end section 25 immediately adjacent to the inner annular wall 13 of the main body 1. The waste gas can pass through the end section 25. A first annular receiving space 26 is formed on outer side of the end section 25, in which a first annular muffling member 24 is accommodated. In this embodiment, a hollow annular section 27 outward extends from the end section 25 of the plastic sleeve 2. A cap body 28 through which the waste gas can be exhausted is fitted on the hollow annular section 27 to define the first annular receiving space 26.

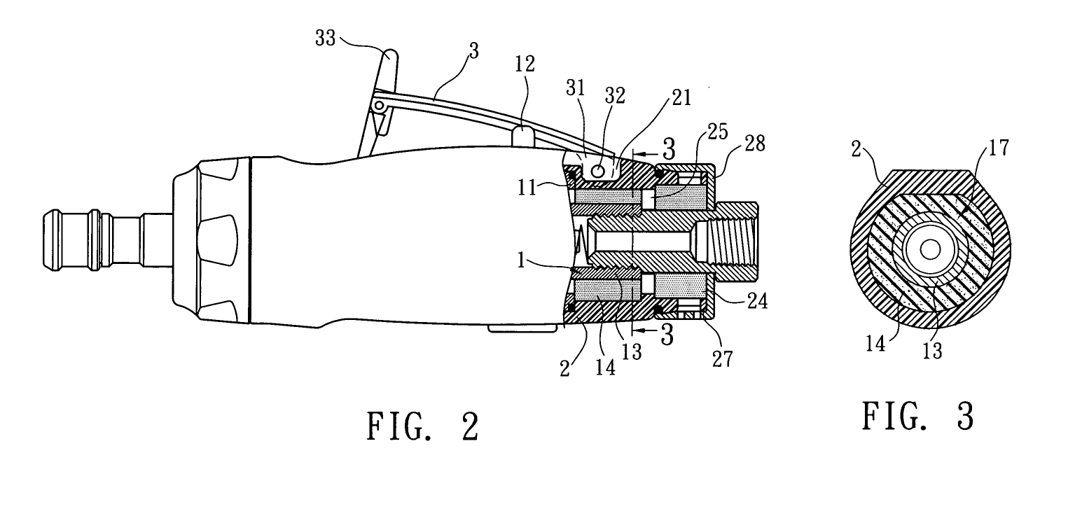

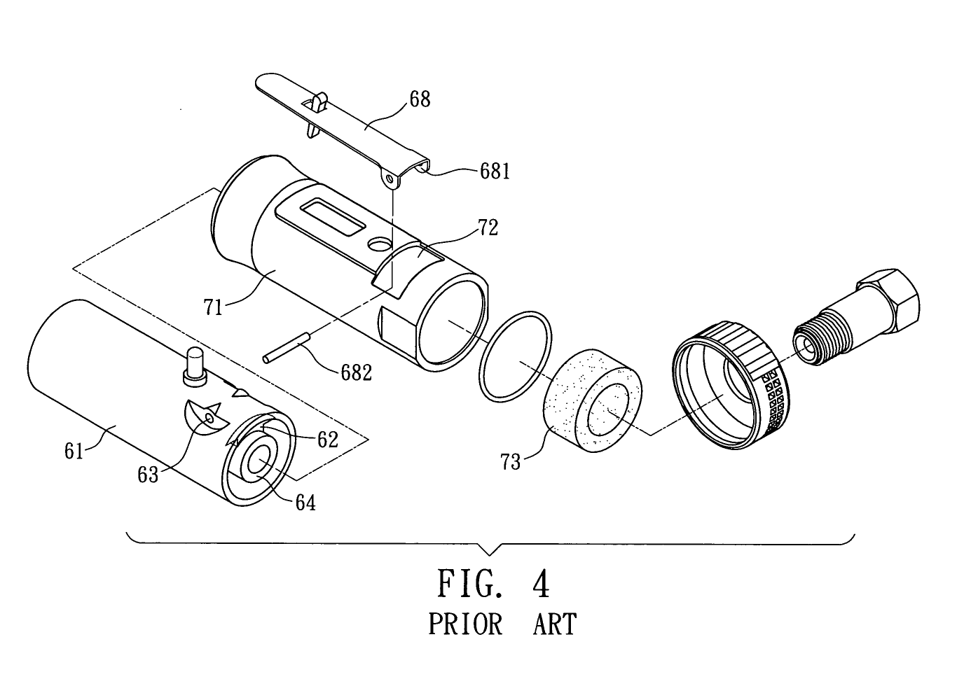

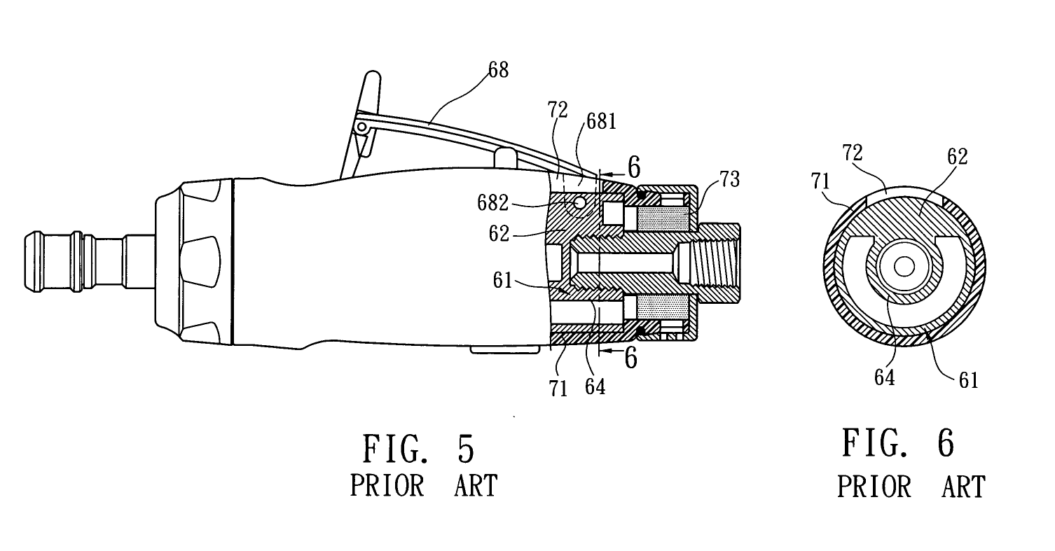

After the plastic sleeve 2 is fitted around the main body 1, a second annular receiving space 17 is defined between an outer circumference of the inner annular wall 13 of the main body 1 and an inner circumference of the plastic sleeve 2. In the second receiving space 17, there is no component connecting with the inner annular wall 13 of the main body 1 and the plastic sleeve 2. That is, the second receiving space 17 is not occupied by any other component. A second annular muffling member 14 is disposed in the second annular receiving space 17 and fitted around the annular wall 13. Two ends of the second annular muffling member 14 respectively abut against the end sections 111, 25 which permit the waste gas to pass through. The first and second annular muffling members 24, 14 have the same size. Accordingly, in addition to the original annular muffling member 24, another annular muffling member 14 with the same size and specification can be further installed in the rear end of the plastic sleeve 2. In use of the pneumatic tool, the two muffling members 14, 24 are able to achieve enhanced muffling effect for reducing the noise. In FIG. 2, it seems that the two muffling members 14, 24 are slightly different in size. This is because the muffling members are flexible and compressible. When accommodated in the limited spaces of the structure of the pneumatic tool, the muffling members are deformed. Therefore, the sizes of the muffling members are visually different. However, it should be noted that in fact, the muffling members 14, 24 have the same size and specification.

According to the above arrangement, the pneumatic tool of the present invention has the following advantages:
1. The processing procedure is simplified and the manufacturing cost is lowered. The pinholes 22 of the plastic sleeve 2 can be formed at the same time when the plastic sleeve 2 is molded. Therefore, the press lever 3 can be directly pivotally connected with the pin seats 21 of the plastic sleeve 2 to simplify the processing procedure of the main body 1. Accordingly, the manufacturing cost of the main body 1 is lowered.
2. A receiving space is reserved for an additional muffling member so as to enhance the muffling effect. After the plastic sleeve 2 is fitted around the main body 1, an annular receiving space 17 is defined between an outer circumference of the annular wall 13 of the main body 1 and an inner circumference of the plastic sleeve 2. An annular muffling member 14 can be fitted in the annular receiving space 17 around the annular wall 13 in addition to the original muffling member 24 installed in the rear end of the plastic sleeve 2. Therefore, in use of the pneumatic tool, when the air is exhausted from the pneumatic motor (not shown) in the main body 1, the air will goes through the two muffling members 14, 24 for effectively muffling the noise.

The above embodiments are only used to illustrate the present invention, not intended to limit the scope thereof. Many modifications of the above embodiments can be made without departing from the spirit of the present invention.

What is claimed is:

1. A pneumatic tool comprising:
a cylindrical main body in which a speed-adjusting section is disposed, the speed-adjusting section having an end section through which waste gas can pass, the end section being radially connected with an inner annular wall which axially outward protrudes from the end section of the speed-adjusting section of the main body, the annular wall having an outer diameter smaller than an outer diameter of the main body; and
a hollow barrel-shaped plastic sleeve fitted around the main body, two opposite pin seats being disposed on one side of the plastic sleeve, each pin seat having a pinhole, a pin member being fitted through two lugs of a press lever and the pinholes of the pin seats to pivotally connect the press lever with the plastic sleeve, the plastic sleeve having an end section immediately adjacent to the inner annular wall of the main body, through which end section the waste gas can pass, a first annular receiving space being formed on outer side of the end section of the plastic sleeve, a first annular muffling member being accommodated in the first annular receiving space, a second annular receiving space being defined between an outer circumference of the annular wall of the main body and an inner circumference of the plastic sleeve, in the second receiving space, there being no component connecting with the inner annular wall of the main body and the plastic sleeve, whereby the second receiving space is not occupied by any other component, a second annular muffling member being disposed in the second annular receiving space and fitted around the annular wall, two ends of the second annular muffling member respectively abutting against the end sections of the speed-adjusting section and the plastic sleeve, which end sections permit the waste gas to pass through, the first and second annular muffling members having the same size.

2. The pneumatic tool as claimed in claim 1, wherein a hollow annular section outward extends from the end section of the plastic sleeve, a cap body through which the waste gas can be exhausted being fitted on the hollow annular section to define the first annular receiving space.
